(19) United States
(12) Patent Application Publication
(10) Pub. No.: US 2003/0141023 A1
(43) Pub. Date: Jul. 31, 2003

(54) Sectional lifting door or folding door

(76) Inventor: Edgar Griebel, Ochsenfurt (DE)

Correspondence Address: BIRCH STEWART KOLASCH & BIRCH, PO BOX 747, FALLS CHURCH, VA, 22040-0747, US

(21) Appl. No.: 10/181,971

(22) PCT Filed: Jan. 18, 2001
(86) PCT No.: PCT/DE01/00224

(51) Int. Cl. E06B 7/28

(52) U.S. Cl. 160/180

(57) ABSTRACT

The invention relates to a segmented lifting or folding gate, which is vertically movable and consists of a plurality of segments (1), adjacent segments (1) being pivotable relative to one another at their ends along horizontally extending pivot axes (2), comprising a door, which consists essentially of cases and a door leaf, the door leaf being composed of a plurality of door leaf segments (4), which are pivotable relative to one another and whose pivot axes (5) extend coaxially to the pivot axes of the gate segments (2), and wherein the door leaf extends to the floor (6) when the gate is closed, the door leaf or the case being provided with at least one opening (11), at least one sliding bolt (9) being arranged axially in the floor region of the case (10) or of the door leaf, so as to be horizontally displaceable in the main plane of the gate, and the sliding bolt (9) engaging in the opening (11) when the door is closed.

The invention relates to a segmented lifting or folding gate, which is vertically movable and consists of a plurality of segments, adjacent segments being pivotable relative to one another at their ends along horizontally extending pivot axes, comprising a door, which consists essentially of cases and a door leaf, the door leaf being composed of a plurality of door leaf segments, which are pivotable relative to one another and whose pivot axes extend coaxially to the pivot axes of the segments.

Segmented lifting or folding gates have been known for many years and are usually composed of lamellar, essentially rectangular plate-shaped segments, two vertically adjacent segments extending along a common, horizontal pivot axis, which extends parallel to the longitudinal sides of the segments, and being pivotable with respect to one another. As a material for the segments, inter alia, light metals such as aluminium are used. A distinction is here made between lifting gates, in which the segments are pivoted essentially through 90° during lifting and when open the gate extends parallel to the ceiling, and folding gates, in which the adjacent segments are folded together in the manner of a concertina during opening in order to be able to close large-area openings in buildings, for example garage gates or industrial gates, without using rigid gate wings which swing out to an extended amount.

To allow passage of the gates for an individual person, without the need to open the entire gate, it is known to integrate doors in these gates, the door leaf also being composed of a plurality of segments which are pivotable relative to one another, and the pivot axes of these door leaf segments extend coaxially to the above-described pivot axes. To increase the stability of the construction, the door is installed in a door frame consisting of vertically and horizontally extending cases. It should be possible to use these doors as escape doors, for example in the event of a fire, if the gate cannot be opened in a conventional manner.

A disadvantage in the case of the gates known hitherto, with an integrated door, can be seen in the fact that, on the underside of the doors, a horizontally extending case or threshold is always arranged, which, particularly in emergencies, when rapid departure from the building is necessary, represents a trip obstacle, over which persons can fall and injure themselves, or the evacuation of the building is delayed. This threshold has so far been regarded as indispensable, since on one hand it serves to provide the entire gate construction with sufficient stability when closed and on the other hand prevents a torsion of the floor section perpendicular to the main plane of the gate when the gate is opened. With interlocking contact of the door leaf, this stable door frame surrounding the door opening also prevents the pivotable segments of the door leaf moving relative to the gate. This threshold is also the reason why such doors are not approved as an escape route.

On the basis of the prior art, it is the object of this invention to create a lifting or folding gate with a door such that the horizontally extending floor threshold below the door leaf can be eliminated without affecting the constructional stability of the gate, and a torsion of the gate segments or a relative movement of the door leaf with respect to the gate does not occur during opening.

This object is achieved according to the invention in that the door leaf extends to the floor when the gate is closed, the door leaf or the case is provided with at least one opening, at least one sliding bolt is arranged axially in the floor region of the case or of the door leaf, so as to be horizontally displaceable in the main plane of the gate, and the sliding bolt engages in the opening when the door is closed.

The gist of the invention consists in the fact that the door leaf is fixed by means of at least one sliding bolt and at least one co-moving locking element relative to the case and thereby relative to the gate. The sliding bolt is displaceable axially, that is to say along its longitudinal axis, extending in a horizontal direction in the main plane of the gate. It may be arranged either in the door leaf or in the case surrounding the door. For fixing, an opening is provided in the case or in the door leaf, which corresponds to the displaceable sliding bolt, that is to say its depth and/or its diameter is matched to the dimensions of the sliding bolt. For locking the door leaf when closed, the sliding bolt, which is arranged in the floor region of the door leaf or of the case, is displaced axially, and thereby engaged in the opening, and a movement of the door leaf, or of the floor segment perpendicular to the main plane of the door is prevented. To this end, the sliding bolt is in an ideal case arranged on the side of the door leaf opposite the door hinges, on which the door handle and lock are disposed.

The advantage of the invention consists in the fact that, by virtue of the extension of the door leaf to the floor, that is to say the lack of a potential trip obstacle in the form of a door threshold, this door can be used as an escape route. In addition, on lifting of the gate, at least the floor segment of the door leaf is fixed relative to the surrounding gate section and thereby a torsion of the gate, or a relative movement of the door leaf with respect to the gate is prevented.

Advantageous embodiments of the invention are the subject of sub-claims.

An advantageous further development of the invention consists in the sliding bolt, during displacement into the opening, pressing or pushing a locking element (for example, a pawl) sidewards, the latter, with an end formed as a detent, catching behind the edge of a retaining plate, also described as an abutment, on the door or gate segment, and engaging. By means of the pivoting and subsequent engagement of the locking element, movement of the door leaf or at least of its floor segment in the main plane of the gate itself is prevented.

If the sliding bolt is arranged in the door leaf and the associated opening in the case, then the locking element must also be located in the case and engages behind the retaining plate, which is then mounted on the door leaf.

Advantageously the door leaf and the cases surrounding the door are each equipped with a plurality of the above-described sliding bolts and locking elements. The door leaf can thereby be fixed at multiple points, and in particular with a door leaf composed of a plurality of segments, the sliding bolts and locking elements can be arranged in the lateral lower and/or upper edge regions of the door to avoid a relative movement of the individual door leaf segments.

It is proposed to dispose the axially displaceable sliding bolts in the case and the thereto corresponding openings in the door leaf. In this embodiment it is possible also to accommodate the below-described drive of the sliding bolts on or in the region of the cases, that is to say in the gate.

Alternatively thereto, the sliding bolts can also be disposed in the door leaf and the openings in the case. The energy supply, for example an electrical lead for an electrical bolt drive, can thereby be guided in an appropriate manner, for example with flexible cables, from the gate into the door leaf.

For driving the sliding bolts, it is proposed that they are movable electromagnetically, for example via electrical servomotors or with magnetic switches, hydraulically or pneumatically by means of hydraulic or pneumatic systems known to the person skilled in the art. Mechanical movement of the sliding bolt may take place, for example, in the manner of a snap lock used in conventional doors, that is to say the sliding bolt is moved by spring force and engaged in the opening. To this end the tip of the sliding bolt may also be rounded in a hemispherical manner to permit engagement and disengagement out of the opening. Furthermore, it is known to the person skilled in the art to provide any arbitrary mechanical device, which locks the sliding bolt in the closed position as soon as the door lifted.

A further advantageous embodiment of the invention consists in a vertical arrangement, on the underside of the door leaf, of further bolts in the main plane of the gate, which are possibly displaceable and, when the gate is closed, can engage in the corresponding opening in the floor. An additional displacement, which may be desirable or required for security considerations, of the bolts can also be implemented in the above-described manner. In both embodiments, the bolts initially serve to stabilise the door when closed, that is to say that a movement of the gate and of the door perpendicular to its main plane is prevented. Such a movement, for example under the influence of a strong wind pressure, would in the long term lead to damage of the gate. The additional displaceability of the bolts by means of a drive, particularly in the region of the door serves as additional securing against unauthorized use.

Advantageously the length of the bolts is three to eight times that of the bolt diameter, With a suitable choice of material, in particular metal or stainless steel, bolts with such dimensions can receive a maximum flexural moment perpendicular to their longitudinal axis without deforming under its effect.

In an advantageous embodiment of the invention, by means of at least two of the vertically arranged bolts, the axially displaceable sliding rods, the movement of the sliding bolts can be driven. To this end the upper region of the two sliding rods can be formed as a toothed rack, which on its vertically upward movement, is deflected via gear wheels and a steel strip, and draws the sliding bolt out of the associated opening.

Here the sliding bolt is advantageously moved against a compression spring, which is tensioned by the movement.

Overall, on closing of the gate the sliding bolt is moved back and the door is released. During the opening of the gate, the sliding bolts, driven by the relaxation of the compression springs, spring back into the openings and lock the door

Simultaneously with this operation the door segments are secured by the locking elements, which engage behind the retaining plates as described above.

Overall, by means of these jointly acting devices, the door is locked when the gate is opened and released for use after it is closed.

To increase the reliability of use of the gate, it is proposed that, at the lower edge of the gate, an electromagnetic safety strip, which is known per se, is arranged, with which a strip-shaped transmitter can be moved in a vertical direction against a spring force.

If, on closing of the gate, an object or a person is located below the gate, the contact strip is moved relatively to the gate by the resistance of the object, and an electrical contact is made, which is connected to an automatic cut-off for the gate drive. Advantageously, the safety strip is of three-part design, that is to say that a strip is mounted to the left and right of the gate and on the door at the bottom edge in each case. Here, the person skilled in the art can advantageously connect the strips to one another in a suitable manner, such that, on tripping even of only one strip, the automatic cut-off responds and the gate drive cuts off. By this means safety is ensured in the event of obstruction under all three gate parts.

A further advantage is provided by a device with which that part of the safety contact strip mounted on the lowermost door leaf segment can be vertically pivoted or lifted, because the door can only be opened easily if the contact strip is not lying on the floor.

To lift the contact strip from the floor, a drive can be installed, which is activated when the door is opened, for example even when the door latch is operated.

To allow use of the door also as an escape route, it is equipped with a panic lock known to the person skilled in the art. This permits the opening of even a locked door from the inside, for example by simply pushing down the door latch. By this means, the rapid evacuation of persons from a building is permitted, even when they do not have a suitable key for the door.

With a drive of the vertically extending bolts provided on the lower edge of the door, it is recommended to actively connect it to the door handle or the door lock. That means that, on operation of the door handle or door lock, for example to open the door, the bolts are displaced synchronously. To open the door, they must be drawn upwards out of the openings in the floor and inserted during closing.

The drive of the bolts may also take place here as described above, and, for example on opening of the doors, an electrical contact may be made, which sets an electrical or magnetic bolt drive into movement. In particular, an active mechanical connection between the bolt and door handle is proposed, which consists of a rack, the latter being equipped at the level of the door lock with a toothed rack, which engages directly with a toothed quadrant, which is pivoted via the door latch about a horizontal axis. The rack and the sliding bar connected to the bolt must thereby be pivoted relative to one another at the level of the horizontal pivot axes, at which the individual adjacent segments can be pivoted relative to one another, must also have a coaxial joint to permit the buckling or folding operation on opening of the gate.

To prevent a movement of the door leaf in a horizontal direction in the main plane of the gate, the door leaf and/or the vertical cases are equipped with hook-like devices, which, when the door is closed, catch behind correspondingly formed projections on the cases or door leaf. In particular, these hooks are disposed in the region of the bolts to prevent pulling open of the gap between the door leaf and case, for example during opening.

A further advantageous embodiment of the invention consists in a pressure roller, which is mounted on both narrow sides of the gate in the lower region and on closing of the gate runs on a centring or locking curve, which is mounted in the lower region of the gate case. By this means the gate and the door are brought together in the lower region, their position is fixed and the bolt are centred over the openings.

By this means it is achieved that the sliding bolts are introduced with accurate fit into the opening, the locking element being pivoted such that it engages behind the retaining plate and at the same time makes the electrically conducting contact between the individual parts of the safety contact strip.

In order that the goal of a precise centring is achieved, which ensures perfect functioning of the locking mechanism, the height of the centring or locking curve is advantageously designed so as to be variably settable, so that it can be adjusted at any time.

Further details, features and advantages of the invention can be taken from the following descriptive part, in which exemplary embodiments of the invention are described in greater detail with reference to the drawings, wherein

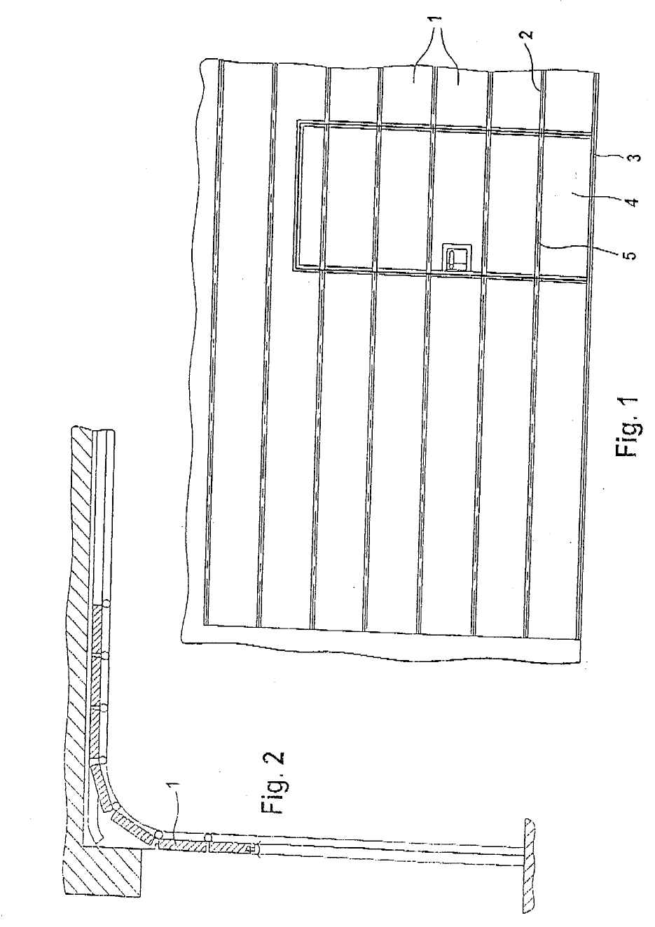

FIG. 1 shows a segmented lifting gate with door in elevation

FIG. 2 shows the gate in a semi-lifted state in cross-section

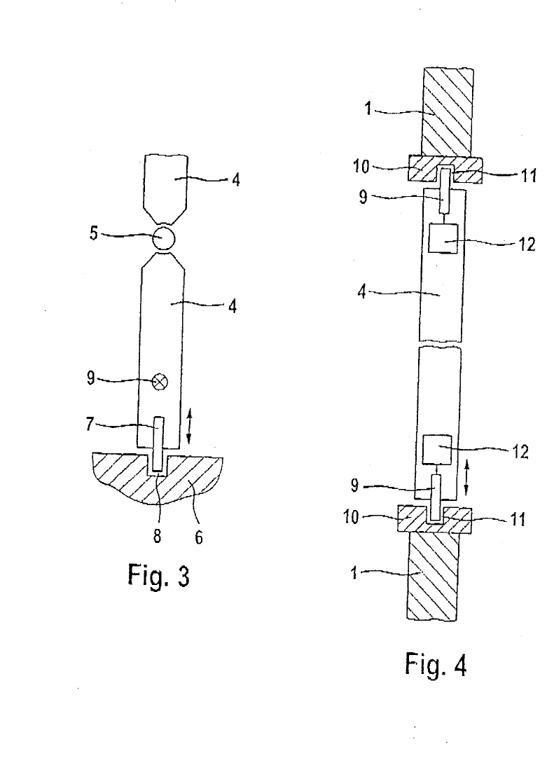

FIG. 3 shows the floor door segment in horizontal cross-section

FIG. 4 shows a vertical cross-section through the door

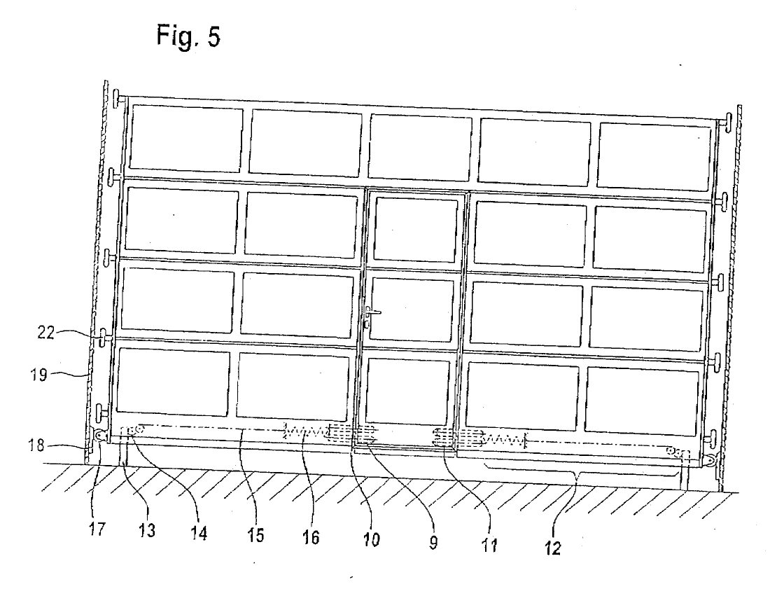

FIG. 5 shows a vertical cross-section through the gate at the level of gate rollers

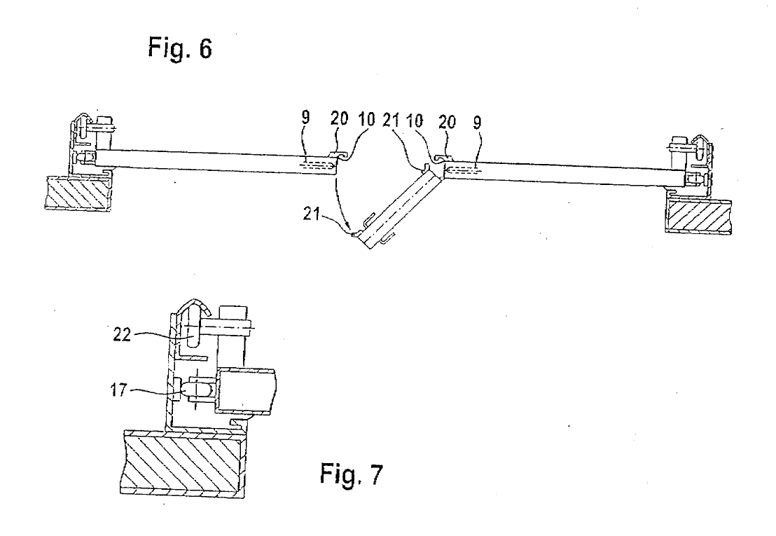

FIG. 6 shows a horizontal cross-section through the gate in the region between the door latch and the door top edge

FIG. 7 shows a detail from FIG. 6

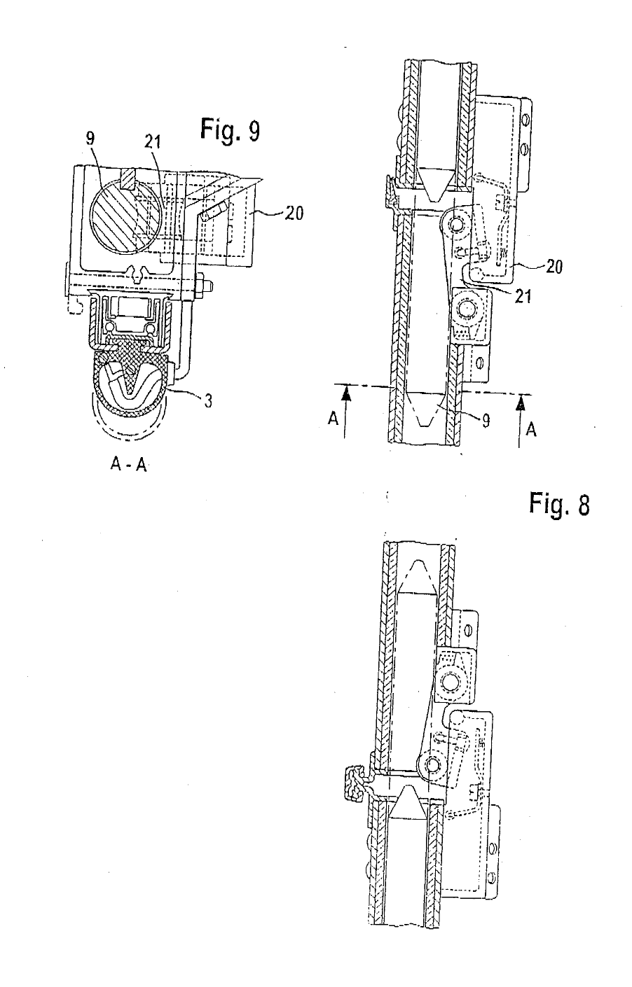

FIG. 8 shows a detail in the region of the door case of the horizontal cross-section through the door

FIG. 9 shows a detail in the lower region of the door from the vertical cross-section through the door

The exemplary embodiment shown in FIG. 1 of the invention is a segmented lifting door, which consists of a plurality of essentially rectangular segments (1), which are pivotable relative to one another parallel to their longitudinal sides on horizontally extending pivot axes (2). To permit passage of the gate for persons without the gate itself needing to be opened, a door is inserted, whose door leaf in turn is composed of individual door leaf segments (4), the horizontal pivot axes (5) between adjacent door segments (4) being arranged coaxial to the above-mentioned pivot axes (2) of the gate. At the lower edge of the gate and the door, a three-part electrical safety contact strip (3) is mounted, which is coupled to an automatic cut-out for the gate drive.

FIG. 2 shows the lifting gate in a semi-lifted state. Here in the angle between the wall and ceiling, a pivoting of the individual segments (1) through essentially 90° takes place such that the gate extends parallel to the ceiling when it is completely opened.

FIG. 3 shows the two lowermost floor segments (4) of a door, according to the invention, of a lifting gate when closed. The lowermost segment (4) is essentially interlocking with its lower edge on the floor (6), for sealing, an additional rubber lip can be attached to it. A bolt (7), which is arranged in the main plane of the gate and is axially displaceable possibly in a vertical direction, here engages into a corresponding opening (8) in the floor (6) below the gate, as indicated by the arrow. By this means movement of the gate or of the door perpendicular to the plane of the gate, for example under the effect of wind pressure, is prevented. Between the two segments (4), a pivot axis (5), which can be of any on which the two segments (4) can be pivoted relative to one another. Furthermore, a sliding bolt (9) is shown, which can be caused to engage in a case (10), wherein it can be displaced axially, perpendicular to the plane of the drawing. To simplify the diagram, a drive device for the bolts (7, 9) has not been illustrated. It can take a variety of embodiments either electromagnetic, pneumatic or mechanical, and also be connected to a suitable control electronics.

FIG. 4 shows the segment (1) of a gate comprising a segment (4) of the door leaf shown in vertical cross-section. In the door leaf, a sliding bolt (9) in each case is arranged laterally on the left and right, which can be displaced axially in the horizontal direction in the main plane of the gate, as is indicated by the arrow. It may be brought into engagement with a corresponding opening (11) in the case (10), which is arranged surrounding the door openings on three sides. To actuate the sliding bolt (9), a freely optional (12) is used.

FIG. 5 shows a vertical section through the gate at the height of the rollers. In the lower region of the gate, the two sliding rods (13) designed as a toothed rack, whose movement is deflected by the gear wheels (14) (pinions) and the steel strip (15) to the sliding bolt (9). During closing of the door, the steel strip (15) is unrolled. It thereby pulls the sliding bolts (9) out of the openings and tensions the compression springs (16), whose spring force, on relaxation of the springs, during opening of the gate, pushes the sliding bolts (9) back into the openings (11).

At the narrow side of the gate, the pressure rollers (17) are mounted, which, during closing of the gate have run along the centring or locking curve (18) and have centred the gate. During opening of the gate, they run in the upper region of the gate case on rails (19) or freely.

FIG. 6 shows a horizontal section through the gate with a partly open door. The retaining plates (20) or abutments arranged on the door case can be clearly recognised, behind which the locking elements (21) (e.g. pawls) arranged on the door engage in order to fix the door in the case (10).

FIG. 7 shows a detail of FIG. 6, in which the arrangement of rollers (22) and pressure roll (17) to one another are made clear.

FIG. 8 shows a section through the door and the door case at the level of the sliding bolts (9). Holding strips (20) and the locking element (21) are recognisable, which projects into the movement cross-section of the sliding bolt (9) and during displacement of the sliding bolt (9) is pivoted by the latter such that the end designed in the form of a detent engages behind the edge of the retaining plates (20) on the individual gate segment or door segment.

FIG. 9 shows a cross-section through the lower region of the door. The safety contact strip (3) and the locking element (21) projecting into the movement cross-section of the shear bolt (9) and the retaining plate (20) can clearly be seen.

1. Segmented lifting or folding gate, which is vertically movable and consists of a plurality of segments, adjacent segments being pivotable relative to one another at their ends along horizontally extending pivot axes, comprising a door, which consists essentially of cases and a door leaf, the door leaf being composed of a plurality of door leaf segments, which are pivotable relative to one another and whose pivot axes extend coaxially to the pivot axes of the segments, characterised in that
door leaf extends to the floor (6) when the gate is closed,
door leaf or the case (10) is provided with at least one opening,
at least one sliding bolt (9) is arranged axially in the floor region of the case (10) or of the door leaf, so as to be horizontally displaceable in the main plane of the gate, and
the sliding bolt engages in the opening when the door is closed.

2. Segmented lifting or folding gate according to claim 1, characterised in that the sliding bolt (9), during displacement into the opening (11), presses or pushes a locking element (for example, a pawl) sidewards, the latter, with an end formed as a detent, catching behind the edge of a retaining plate, also described as an abutment, on the door or gate segment, and engaging.

3. Segmented lifting or folding gate according to claim 1 or 2 characterised in that a plurality of sliding bolts (9) are provided for fixing the door leaf relative to the case (10), in particular in the lower and upper lateral edge regions of the door leaf and a plurality of locking element (21) (e.g. pawls) are also mounted there.

4. Segmented lifting or folding gate according to claim 1, 2 or 3, characterised in that the displaceable sliding bolts (9) and the retaining plates (20) are arranged in the case (10) and the openings (11) and the locking elements (21) in the door leaf.

5. Segmented lifting or folding gate according to claim 1, 2 or 3, characterised in that the displaceable sliding bolts (9) and the retaining plates (20) are arranged in the door leaf and the openings (11) and locking elements (21) in the case (10).

6. Segmented sliding or folding gate according to one of the preceding claims, characterised in that the sliding bolts (9) are electromagnetically and/or hydraulically and/or pneumatically and/or mechanically moveable.

7. Segmented sliding or folding gate according to one of the preceding claims, characterised in that, in the lower edge region of the door leaf, one or more bolts (7) arranged vertically in the main plane of the gate are provided, which, when the door and the gate are closed, engage or engages in one or more openings (8) in the floor.

8. Segmented sliding or folding gate according to one of the preceding claims, characterised in that the length of the bolts (7, 9) corresponds to three to eight times their diameter.

9. Segmented sliding or folding gate according to claim 7, characterised in that at least two of the vertically arranged bolts (7) are axially movable.

10. Segmented sliding or folding gate according to claim 9 characterised in that said bolts, are vertically displaceable rods (13), drive the movement of the sliding bolts (9).

11. Segmented sliding or folding gate according to claim 10, characterised in that the rods (13) are designed as a toothed rack in the upper region, the movement of which draws, via gear wheels (pinions) (14) and a steel strip (15), the sliding bolts (9) out of the associated openings (11).

12. Segmented sliding or folding gate according to claim 11, characterised in that the sliding bolt (9) is drawn out of the opening (11) against a compression spring (16), which is tensioned by the movement.

13. Segmented sliding or folding gate according to one of the preceding claims, characterised in that, on the bottom edge of the gate, an electrical safety contact strip (3) is provided, and in particular the latter is in three parts.

14. Segmented sliding or folding gate according to claim 13, characterised in that the automatic cut off for the gate drive is designed electrically such that it respond even in the event of resistance against a single part of the three-part contact strip (3) and shuts off the drive.

15. Segmented sliding or folding gate according to claim 13 or 14, characterised in that that part of the safety contact strip (3) which is mounted on the lowermost door leaf segment can be pivoted or lifted vertically.

16. Segmented sliding or folding gate according to claim 15, characterised in that the vertically pivotable or liftable part of the safety contact strip (3) is moved by a correspondingly designed drive during opening of the door.

17. Segmented sliding or folding gate according to claim 16, characterised in that the drive is controlled by means of an active connection, for example with the door latch, during opening.

18. Segmented sliding or folding gate according to one of the preceding claims, characterised in that a panic lock is mounted on the door.

19. Segmented sliding or folding gate according to one of the preceding claims, characterised in that the vertically arranged bolts (7) are displaceable and, like the rods (13) are in active connection with the door handle and/or the door lock.

20. Segmented sliding or folding gate according to claim 17 or 19, characterised in that the active connection is electromagnetic and/or hydraulic and/or pneumatic and/or mechanical, in particular, with a mechanical active connection via a rack, the latter is pivotable at the level of the horizontal pivot axes (1).

21. Segmented sliding or folding gate according to one of the preceding claims, characterised in that the door leaf and/or the vertical cases (10) are provided with hook-like devices, the projections engaging on the vertical cases (10) and/or laterally on the door leaves.

22. Segmented sliding or folding gate according to one of the preceding claims, characterised in that, on both narrow sides in the lower region of the gate, there is mounted a pressure roller (17), which, as the door is being closed, runs on a centring or locking curve (18), which is mounted in the lower part of the gate case.

23. Segmented sliding or folding gate according to claim 22, characterised in that the pressure rollers (17) run on runners in the remaining region of the gate case (19) or freely.

24. Segmented sliding or folding gate according to one of the preceding claims, characterised in that the running level of the centring or locking curve (18) is variably adjustable.
